(19) United States
(12) Patent Application Publication
(10) Pub. No.: US 2010/0324858 A1
(43) Pub. Date: Dec. 23, 2010

(54) METHOD AND DEVICE FOR DETERMINING THE CHANGE IN THE FOOTPRINT OF A TIRE

(76) Inventors: Thorsten Pannek, Stuttgart (DE); Marian Keck, Leonberg (DE)

Correspondence Address: KENYON & KENYON LLP, ONE BROADWAY, NEW YORK, NY, 10004, US

(21) Appl. No.: 12/735,531

(22) PCT Filed: Nov. 26, 2008
(86) PCT No.: PCT/EP2008/066178

§ 371 Date: Jul. 22, 2010

(30) Foreign Application Priority Data
Feb. 6, 2008 (DE) 102008007775.5

(51) Int. Cl. B60C 23/06; G01P 15/00

(52) U.S. Cl. 702/141; 73/146

(57) ABSTRACT

A method for determining a change in the footprint of a tire, on the basis of a signal, which may be assigned to the rotation of the tire, is output by a sensor, and corresponds to an acceleration, the determination being performed by the following: recording at least one acceleration signal g₁, which is able to be assigned to the rotation of the tire; reading out a stored reference acceleration signal g₀, which is able to be assigned to the rotation of the tire; calculating a difference between the acceleration signal g₁ and the reference acceleration signal g₀; and determining the change in the footprint of the tire on the basis of the calculated difference between the acceleration signals.

### FIELD OF THE INVENTION

The present invention relates to a method for determining the change in the footprint of a tire. Furthermore, the present invention relates to a device for executing a method for determining the change in the footprint of a tire.

### BACKGROUND INFORMATION

With the increase in vehicles participating in road traffic, the demands on active and passive safety systems in the vehicles have also risen. Because of this, the number of safety systems used in vehicles, such as antilock brake system, anti-slip control, electronic stability program, airbag, etc., as well as their complexity, have increased in recent years. In addition to the safety systems, more and more comfort systems, such as automatic level control, adjustable suspension, etc., have also been integrated into the vehicles at the request of the driver. These safety and comfort systems are instructed by greatly varying data from a plurality of various sensors. The above-mentioned safety and comfort systems also include so-called tire pressure monitoring systems, which are becoming increasingly widespread. In the case of tire pressure monitoring systems, the tire pressure is monitored, so that the driver may be warned of a sudden or gradual pressure loss in the tires. In addition, the load state of the vehicle also plays a significant role in tire pressure monitoring systems, because a load-dependent tire pressure recommendation, for a single wheel or all wheels, may be output to the driver on the basis of the load state.

Methods and devices which may be used to perform load measurements based on an acceleration signal, the tire pressure, and the temperature are known from the related art.

For example, a method which may be used to determine load changes based on the amplitude curve of the acceleration signal, the tire pressure, and the temperature is known from WO 2005/005950 A1.

However, these known methods have the disadvantage that they also require information about tire pressure and temperature in addition to an acceleration signal for the determination of a load change.

### SUMMARY OF THE INVENTION

The method according to the present invention having the features described herein advantageously has a robust method for determining a change in the footprint of a tire, based on a signal which is able to be assigned to the rotation of the tire and corresponds to an acceleration (acceleration signal), and a signal which corresponds to a reference acceleration (reference acceleration signal), no information about tire pressure and temperature being required. The acceleration acting on the sensor may contain a component in the radial direction.

Advantageous embodiments and refinements of the present invention are made possible by the measures specified further herein.

In an exemplary embodiment, a change in the footprint of a tire is determined on the basis of an acceleration signal, which is able to be assigned to the rotation of the tire and is output by a sensor, having the following steps: recording at least one acceleration signal gₗ, which is able to be assigned to the rotation of the tire; reading out a stored reference acceleration signal g₀, which is able to be assigned to the rotation of the tire; calculating a difference between acceleration signal gₗ and reference acceleration signal g₀; and/or determining the change in the footprint of the tire on the basis of the calculated difference between the acceleration signals.

According to the present invention, the footprint of the tire refers to the tire surface section which is in contact with the roadway.

According to the present invention, the sensor which outputs the acceleration signal may be a piezoelectric acceleration sensor or a micro-electromechanical system. In the case of a piezoelectric acceleration sensor, pressure variations are converted by a piezoceramic sensor lamina into electrical signals, which may be processed further accordingly. In the case of a micro-electromechanical system, the sensor includes a spring-mass system, in which the “springs” are made of silicon webs and the mass is also made of silicon. A capacitance change, which is proportional to the acceleration, may be measured between the springs and the mass through the deflection during acceleration.

The acceleration signal output by the sensor may have a continuous or discrete curve. The acceleration signal output by the sensor may in turn be recorded continuously or in a time-discrete manner, i.e., at specific time intervals.

The recorded acceleration signal may be converted into a pulse-width-modulated signal (PWM signal) using filtering. The PWM signal may have a pulse-duty ratio. The pulse-duty ratio may correspond to the ratio of the tire footprint to the tire circumference. A change in the tire footprint may be detected by a change in the pulse-duty ratio. The change in the tire footprint may occur because of a load change in the vehicle and/or a change in the profile depth.

It is also possible that one or more frequency components are extracted from the recorded acceleration signal using filtering and this extracted frequency component is supplied to a transformation, as described hereafter. This has the advantage that the full information content from the recorded signal is preserved.

In an advantageous embodiment, the spectrum of the acceleration signal is calculated using a transformation. The calculation of the spectrum may be performed using Fourier analysis, fast Fourier analysis, or another suitable calculation method. The thus calculated spectrum may subsequently be scaled with respect to acceleration and/or frequency. The Fourier analysis or the fast Fourier analysis has the advantage that no information content is lost from the recorded signal.

An advantage of this method is that a change in the footprint of the tire results in a proportional change in the spectrum, which may be analyzed accordingly.

According to the present invention, the calculated spectrum of the acceleration signal may be recorded over multiple rotations of the tire and buffered. A mean value or mean spectrum may be calculated from the multiple spectra of the acceleration signals. This mean value may be an arithmetic mean value, a median, or a floating average. The number of acceleration signals recorded in sequence may be 2 to 20, and which may be 4 to 15, and which may be 6 to 10, still more which may be 8.

In an exemplary embodiment, at least one reference acceleration signal may be stored with respect to the acceleration signal output by the rotation of the tire. The at least one reference acceleration signal may correspond to the output acceleration signal of an unloaded, fully loaded, or overloaded tire. It is also possible that the reference acceleration signal is related to the tire type used.

The reference signal may be compared to the detected acceleration signal. The load state of the tire may be derived from the comparison of the signals. A change in the load (increase/decrease) and/or a decrease of the profile depth may also be detected by the comparison of the signals.

A further aspect of the present invention relates to a device for determining a change in the footprint of a tire, which is set up in order to determine a change in the footprint of a tire on the basis of an acceleration signal, which is able to be assigned to the rotation of the tire and is output by a sensor, having the following steps: recording at least one acceleration signal gₗ, which is able to be assigned to the rotation of the tire; reading out a stored reference acceleration signal g₀, which is able to be assigned to the rotation of the tire; calculating a difference between acceleration signal gₗ and reference acceleration signal g₀; and/or determining the change in the footprint of the tire on the basis of the calculated difference between the acceleration signals.

Another aspect of the present invention relates to a computer program which executes the steps of the method according to the present invention when it runs on a computing device.

The present invention is explained in greater detail hereafter by way of example on the basis of the appended drawings.

### BRIEF DESCRIPTION OF THE DRAWINGS

FIG. 1 shows a schematic view of a wheel having an acceleration sensor.

FIG. 2 shows a schematic view of recorded acceleration signals.

FIG. 3 shows a schematic view of spectra of the acceleration signals;

FIG. 4 shows a schematic view of scaled spectra of the acceleration signals.

FIG. 5 shows a flow chart of the method according to the present invention.

FIG. 6 shows a block diagram of a circuit system.

### DETAILED DESCRIPTION

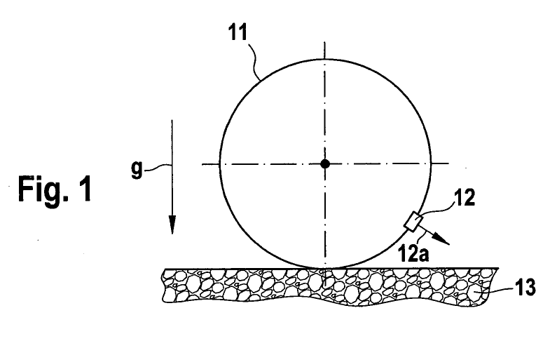

FIG. 1 schematically shows a wheel 11 of a vehicle (not shown) rolling on a roadway 13. An acceleration signal 12 is attached to wheel 11. The wheel may include a rim and a tire. The sensor is attached on or in the tire. The sensor may be a sensor module, which also has a pressure sensor and/or a temperature sensor in addition to an acceleration sensor 12. Acceleration of gravity g acts on wheel 11 and acceleration sensor 12. A centripetal force 12a acts on acceleration sensor 12 in the radial direction outside the footprint of the tire during a rotation of wheel 11. This centripetal force 12a is proportional to the rotational velocity of wheel 11. In the area of the footprint of the tire, the rotational movement of sensor 12 transitions to a linear movement along roadway 13, whereby only acceleration of gravity g still acts on sensor 12.

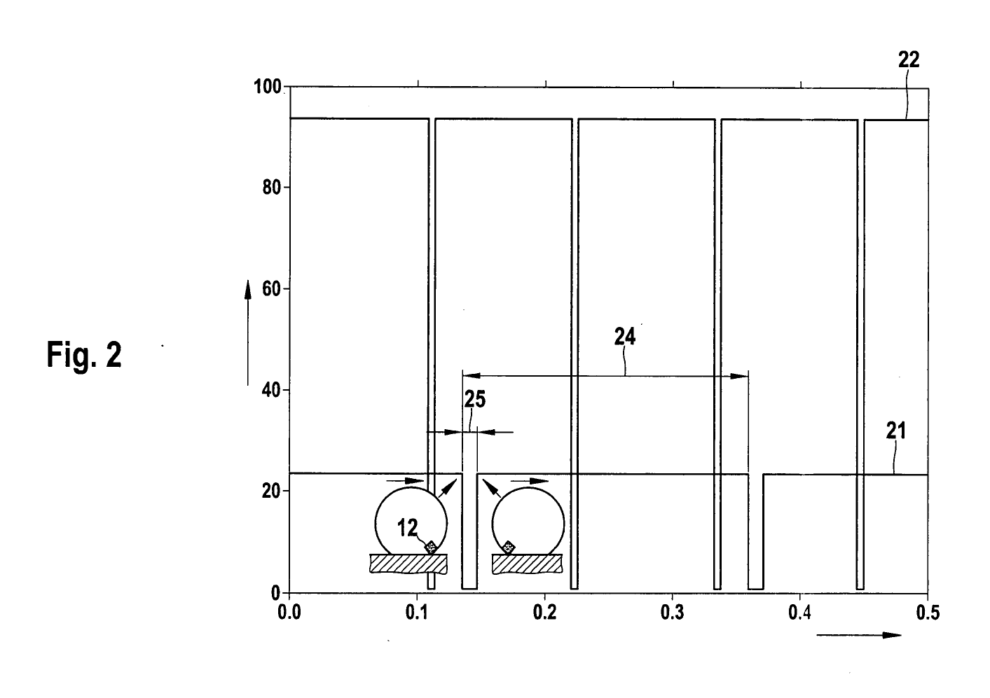

The curve of the acceleration signal output by sensor 12 is schematically shown in FIG. 2. The amplitude of the signal is proportional to the square of the rotational velocity of wheel 11. The time in seconds is plotted on the abscissa of the graph shown in FIG. 2. The acceleration in multiples of acceleration of gravity g is plotted on the ordinate of the graph shown in FIG. 2. Reference numeral 21 identifies the curve of an acceleration signal at a first velocity v1. Reference numeral 22 identifies the curve of an acceleration signal at a second velocity v2, velocity v2 being greater than velocity v1. As already noted, the rotational movement of sensor 12 transitions to a linear movement along roadway 13 in the area of the footprint of the tire. This linear movement lasts until sensor 12 leaves the area of the footprint of the tire again. During the linear movement, only the acceleration of gravity of approximately 1 g acts on sensor 12. The period of time, during which the sensor is in a linear movement, is identified by reference numeral 25. The time span from the beginning of a linear movement to the beginning of a further linear movement, that is, the period duration of the signal, is identified by reference numeral 24. As may be seen from FIG. 2, curve 21 or curve 22 essentially corresponds to a PWM signal. The PWM signal has a pulse-duty ratio. The pulse-duty ratio specifies the ratio between the component of linear movement 25 and period duration 24 for signal curve 21. This is also true with respect to signal curve 22. The absolute change in the pulse-duty ratio is between 1% and 3%, which may be 2%. Therefore, the pulse-duty ratio in one vehicle is between approximately 6% (fully loaded vehicle) and approximately 3% (empty vehicle) as a function of tire pressure, temperature, and tire type. In another vehicle, the pulse-duty ratio may be between approximately 8% (fully loaded vehicle) and approximately 6% (empty vehicle), again as a function of tire pressure, temperature, and tire type.

In an exemplary embodiment, the method according to the present invention is executed in a velocity range between 10 km/h and 100 km/h. If the velocity is below a predetermined threshold value, the signal-to-noise ratio of the acceleration signal is poor, i.e., the noise component of the measuring signal is excessively high. On the other hand, if the velocity of the vehicle is above a further predetermined threshold value, sensor 12 goes into saturation and the area of the tire footprint may no longer be detected.

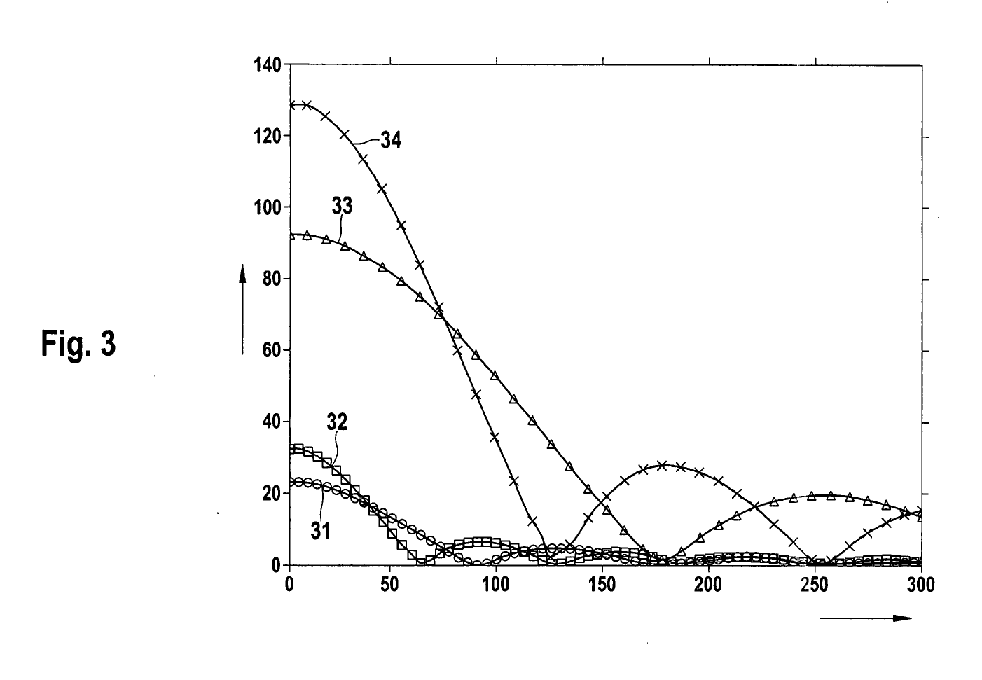

FIG. 3 schematically shows various spectra of acceleration signals. Spectra 31 and 32 relate to a first velocity v1 of approximately 30 km/h, spectrum 31 representing an acceleration signal having a pulse-duty ratio of 5% and spectrum 32 representing an acceleration signal having a pulse-duty ratio of 7%. Spectra 33 and 34, in contrast, relate to a second velocity v2 of approximately 60 km/h, spectrum 33 representing an acceleration signal having a pulse-duty ratio of 5% and spectrum 34 representing an acceleration signal having a pulse-duty ratio of 7%. As may be seen in FIG. 3, an elevation of the tire contact length results in an increase in the pulse-duty ratio of the PWM signal. The increase in the pulse-duty ratio in turn results in a significant rise in the acceleration component of the fundamental frequency and a stronger drop in the higher multiples of this frequency. A reduction of the footprint, in contrast, results in a reduction of the pulse-duty ratio of the PWM signal and thus in a drop in the acceleration signal of the fundamental frequency.

Based on the change in the spectrum in the case of a change in the pulse-duty ratio, an evaluation may be performed with reference to a load change and/or profile depth change. For example, it is possible to subject the acceleration signal, which is output by sensor 12 over one or more wheel revolutions, to a Fourier transform or a fast Fourier transform and to track the rate of change in the frequency-discrete acceleration components in the lower frequency range. If a change is detected between the acceleration components, a load change has occurred. For example, if the drop in the acceleration components becomes steeper toward higher frequencies, an increase in load has occurred. Vice versa, if the drop in the acceleration components is flatter toward higher frequencies, a reduction of the load has occurred. The amount of the rate of change may be used for both qualitative and also quantitative determination of the load change.

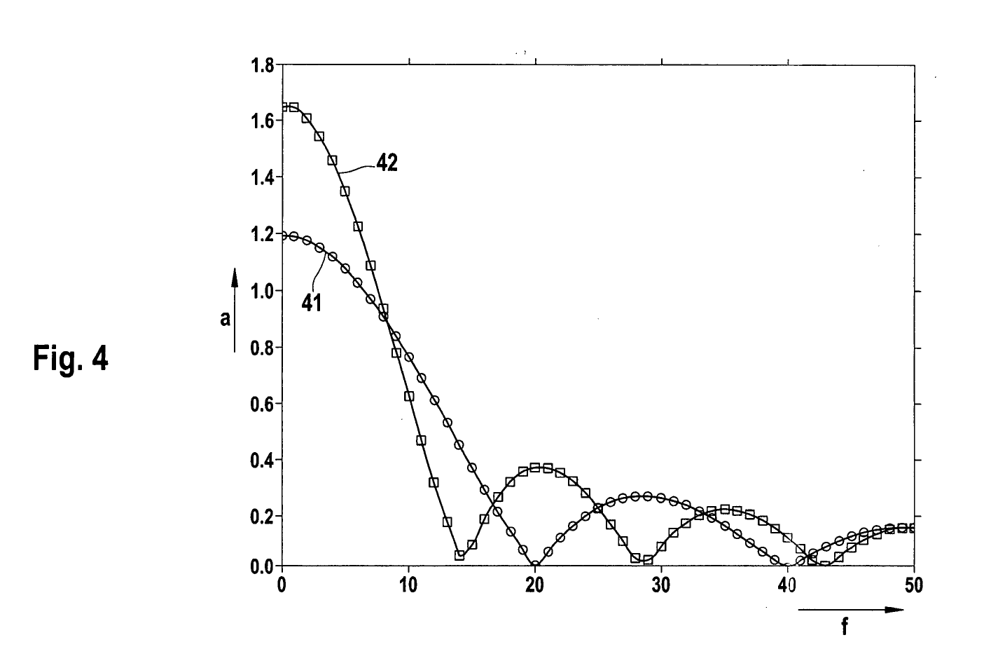

FIG. 4 shows a schematic view of scaled spectra of the acceleration signals. The spectra shown in FIG. 3 are a function of the rotational velocity of wheel 11. In order to compensate for this dependence the calculated Fourier spectrum may be scaled in a further design. An amount proportional to the velocity is, for example, the speed of wheel 11 or, indirectly, its reciprocal, the revolution period. Because the above-mentioned square and linear relationships exist between centripetal acceleration and wheel speed with respect to the velocity, corresponding scaling factors may be used for the amplitude of the acceleration signal and the frequency of the acceleration signal.

In spectra 31, 32, 33, and 34 shown in FIG. 3, the acceleration (abscissa) is multiplied by the square of the revolution period and the frequency (ordinate) is multiplied by the revolution period of the tire. The frequency curves of the signals thus lie one above the other even in the case of different velocities. Spectrum 41 corresponds to scaled spectra 31 and 33 having a pulse-duty ratio of 5%, and spectrum 42 corresponds to scaled spectra 32 and 34 having a pulse-duty ratio of 7%. It may be seen from FIG. 4 that a change in the pulse-duty ratio only results in a change in the curve shape, but not a change in the velocity.

The revolution period of the tire may be ascertained from the time signal of the radial accelerations. The revolution period essentially corresponds to period duration 24. For example, the entry into the area of the tire footprint may be detected via a simple acceleration threshold value slightly above Earth's gravity of 1 g, which is present in the area of the footprint as described above, and may be used for triggering of a time measurement. The time between two entry points corresponds to the tire revolution time.

A further possibility for the analysis is a frequency-discrete amplitude comparison. This may be performed either in the scaled frequency spectrum, or one or more individual frequency components may be extracted from the acceleration signal via one or more bandpass filters. This results in various sine signals, whose amplitude changes in the event of a change in the pulse-duty ratio. Before the pulse-duty ratio is concluded from the amplitude change, the amplitudes may also be scaled via the revolution time using the corresponding method as described above.

On the one hand, the fundamental frequency of the acceleration signal, the wheel speed, or the inverse of the revolution period may be used as a possible filter frequency. The filter frequency of the bandpass filter must be so narrow that multiples of the fundamental frequency may not pass the filter. This is necessary because the phase location of the multiples of the fundamental frequency is significantly shifted. The fundamental frequency is velocity-dependent and may be determined from the tire signal before the filtering. The above-mentioned method may also be used for determining the tire revolution period here. The scaling of the velocity-dependent acceleration amplitude may also be performed on the basis of the revolution time, as described above.

For the described methods for determining the tire footprint length via the frequency analysis, only the signal curves in the area of the tire footprint and their chronological sequence (revolution time) are of interest. Only the centripetal acceleration is important outside the area of the tire footprint. Therefore, recording (sampling) of the acceleration signal is only required in the area of the tire footprint. The sensor is located in this area less than 10% of the tire revolution time. Because of this, the corresponding circuit part may be turned off outside the tire footprint.

The centripetal acceleration or a value proportional thereto may be derived from the presented method of the revolution time determination. If the revolution time is used for determining the centripetal acceleration, it is no longer necessary to know the tire radius precisely.

In addition to the loading or tire profile depth, tire pressure and temperature also have an influence on the footprint. These dependencies may be stored in the sensor module or a central analysis unit in the vehicle. It is also advantageous if the minimum and maximum permissible contact length with respect to wheel load and profile depth are known and stored as a function of pressure and temperature.

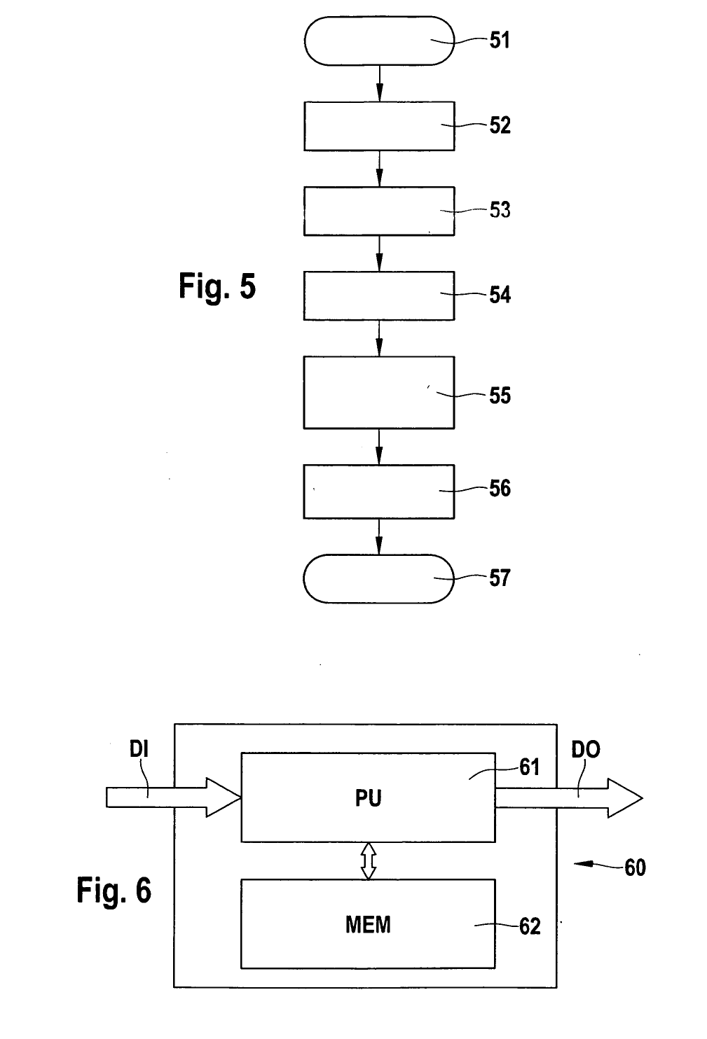

A flow chart of the method according to the present invention is shown in FIG. 5. The method is started in step 51. The method may be started at the beginning of each trip and/or run periodically during the trip. After beginning the method, the initial values are input in step 52. These values may be standard values (empty or fully loaded) or values of a preceding measurement, which have been stored in the memory. If these are values from a preceding measurement, a quantitative determination of the load value as well as a qualitative determination of the load change (lighter—reduction of the load, heavier—increase of the load) may also be acquired. A signal output by acceleration sensor 12 is recorded in step 53. The recorded signal is transformed into a spectrum in step 54. The transformed signal is subsequently compared in step 55 to the initial value read out in step 52. This may be a frequency comparison or an amplitude comparison. A load/load increase change is recognized on the basis of the result of the comparison in step 56. Following step 56, the method is terminated in step 57.

FIG. 6 shows a schematic block diagram of an alternative, software-based embodiment of proposed device 60 for determining a change in the footprint of a tire. The proposed device contains a processing unit PU 61, which may be any type of processor or computer having a control unit, the control unit executing controls based on software routines of a program stored in a memory MEM 62. Program commands are retrieved from memory 62 and loaded into the control unit, of processing unit 61, in order to execute the processing steps of the above functionalities described with reference to FIGS. 2a-c. These processing steps may be executed on the basis of input data DI and output data DO, the input data being able to correspond to at least one acceleration signal which is able to be assigned to the rotation of the tire, and output data DO being able to correspond to a signal corresponding to the change in the footprint of the tire.

A method and a device for determining a change in the footprint of a tire, on the basis of an acceleration signal, which is able to be assigned to the rotation of the tire and is output by a sensor, was described, the determination being performed by at least the following steps: recording at least one acceleration signal gₗ, which is able to be assigned to the rotation of the tire; reading out of a stored reference acceleration signal g₀, which is able to be assigned to the rotation of the tire; calculating a difference between acceleration signal gₗ and reference acceleration signal g₀; and/or determining the change in the footprint of the tire on the basis of the calculated difference between the acceleration signals.

It should be noted that the proposed approaches corresponding to the above-mentioned specific embodiments may be implemented as software modules and/or hardware modules in the corresponding functional blocks. Furthermore, it should be noted that the present invention is not restricted to the above-mentioned specific embodiments, but rather may also be used in other sensor modules.

It is clear from the above statements that, while exemplary embodiments have been shown and described, various changes may be performed without deviating from the fundamental aspects of the present invention. The present invention is accordingly not to be restricted thereto by the detailed description of the exemplary embodiments.

1-12. (canceled)

13. A method for determining a change in the footprint of a tire, on the basis of a signal, which can be assigned to the rotation of the tire, and which is output by a sensor and corresponds to an acceleration, the method comprising:
recording at least one signal, which can be assigned to the rotation of the tire, and which corresponds to an acceleration;
reading out a stored signal, which can be assigned to the rotation of the tire, and which corresponds to a reference acceleration;
calculating a difference between the signal which corresponds to the acceleration and the signal which corresponds to the reference acceleration; and
determining the change in the footprint of the tire based on the calculated difference.

14. The method of claim 13, wherein the signal corresponding to the acceleration is converted into a pulse-width-modulated signal with the aid of filtering.

15. The method of claim 13, wherein at least one frequency component is extracted from the signal corresponding to the acceleration with the aid of filtering.

16. The method of claim 13, wherein the signal corresponding to the acceleration is converted into a spectrum with the aid of transformation.

17. The method of claim 13, wherein the spectrum is scaled with reference to acceleration and frequency.

18. The method of claim 13, wherein multiple signals, which can be assigned to the rotation of the tire, and which correspond to the acceleration, are recorded, and a mean value is calculated from the multiple signals.

19. The method of claim 13, wherein a change in the spectrum of the signal, which corresponds to the acceleration, occurs based on a change in the footprint of the tire.

20. The method of claim 13, wherein the curve of the signal corresponding to the acceleration corresponds to the ratio of the footprint of the tire to the circumference of the tire.

21. The method of claim 13, wherein the signal which corresponds to the acceleration is stored as a signal which corresponds to the reference acceleration.

22. A device for determining a change in the footprint of a tire, set up to determine a change in the footprint of a tire based on a signal, which can be assigned to the rotation of the tire, and which is output by a sensor and corresponds to an acceleration, comprising:
a recording arrangement to record at least one signal, which can be assigned to the rotation of the tire, and which corresponds to an acceleration;
a reading arrangement to read out a stored signal, which can be assigned to the rotation of the tire, and which corresponds to a reference acceleration;
a calculating arrangement to calculate a difference between the signal which corresponds to the acceleration and the signal which corresponds to the reference acceleration; and
a determining arrangement to determine the change in the footprint of the tire based on the calculated difference.

23. A computer readable medium having a computer program which is executable by a processor, comprising:
a program code arrangement having program code for determining a change in the footprint of a tire, on the basis of a signal, which can be assigned to the rotation of the tire, and which is output by a sensor and corresponds to an acceleration, by performing the following:
recording at least one signal, which can be assigned to the rotation of the tire, and which corresponds to an acceleration;
reading out a stored signal, which can be assigned to the rotation of the tire, and which corresponds to a reference acceleration;
calculating a difference between the signal which corresponds to the acceleration and the signal which corresponds to the reference acceleration; and
determining the change in the footprint of the tire based on the calculated difference.

24. The computer readable medium of claim 23, wherein the signal corresponding to the acceleration is converted into a pulse-width-modulated signal with the aid of filtering.

25. The computer readable medium of claim 23, wherein at least one frequency component is extracted from the signal corresponding to the acceleration with the aid of filtering.

26. The computer readable medium of claim 13, wherein the signal corresponding to the acceleration is converted into a spectrum with the aid of transformation.

27. The computer readable medium of claim 13, wherein the spectrum is scaled with reference to acceleration and frequency.

28. The computer readable medium of claim 13, wherein multiple signals, which can be assigned to the rotation of the tire, and which correspond to the acceleration, are recorded, and a mean value is calculated from the multiple signals.

29. The computer readable medium of claim 13, wherein a change in the spectrum of the signal, which corresponds to the acceleration, occurs based on a change in the footprint of the tire.

30. The computer readable medium of claim 13, wherein the curve of the signal corresponding to the acceleration corresponds to the ratio of the footprint of the tire to the circumference of the tire.

31. The computer readable medium of claim 13, wherein the signal which corresponds to the acceleration is stored as a signal which corresponds to the reference acceleration.
